(19) United States
(12) Patent Application Publication
(10) Pub. No.: US 2013/0116030 A1
(43) Pub. Date: May 9, 2013

(54) GAMING SYSTEM AND A METHOD OF GAMING

(71) Applicant: Aristocrat Technologies Australia Pty Limited, North Ryde (AU)

(72) Inventor: Björn Fredrik Gustaf Jacobson, Stockholm (SE)

(73) Assignee: Aristocrat Technologies Australia Pty Limited, North Ryde (AU)

(21) Appl. No.: 13/724,699

(22) Filed: Dec. 21, 2012

Related U.S. Application Data
(63) Continuation of application No. 12/471,782, filed on May 26, 2009, now abandoned.

(30) Foreign Application Priority Data
May 26, 2008 (AU) 2008902655

(51) Int. Cl. G07F 17/32

(52) U.S. Cl. CPC G07F 17/3225
USPC 463/16

(57) ABSTRACT

A gaming system arranged to implement a probabilistic game is disclosed. The system includes an outcome evaluator arranged to determine whether an outcome of an implemented game corresponds to a winning outcome, and a game recorder arranged to record video information indicative of a winning outcome occurring in a game implemented by the gaming system. The system is arranged to provide a player with access to video information relating to a winning outcome obtained by the player. A corresponding method is also disclosed.

### CROSS-REFERENCE TO RELATED APPLICATIONS

The present application claims the benefit of priority to U.S. patent application Ser. No. 12/471,782, filed May 26, 2009, entitled “A GAMING SYSTEM AND A METHOD OF GAMING,” and Australian Provisional Patent Application No. 2008902655, filed on May 26, 2008, entitled “A GAMING SYSTEM AND A METHOD OF GAMING”, both of which are herein incorporated by reference in their entireties.

### FIELD

The present invention relates to a gaming system and to a method of gaming.

### BACKGROUND

It is known to provide a gaming system which includes a game controller arranged to randomly display several symbols from a predetermined set of symbols and to determine a game outcome such as a game win based on the displayed symbols. In some arrangements, a win outcome is defined on the basis of occurrence of symbols along defined win lines which may be preselected or selected by a player prior to display of symbols by the gaming system.

Such gaming systems may commonly be implemented as a stepper machine provided with reels with each reel carrying several symbols of the set, or a video machine wherein selected symbols are displayed on virtual reels on a graphical display device.

However, while such gaming systems provide users with enjoyment, a need exists for alternative gaming systems in order to maintain or increase player enjoyment.

### SUMMARY

In accordance with a first aspect of the present invention, there is provided a gaming system arranged to implement a probabilistic game, the system including:

an outcome evaluator arranged to determine whether an outcome of an implemented game corresponds to a winning outcome; and

a game recorder arranged to record video information indicative of a winning outcome occurring in a game implemented by the gaming system;

the system being arranged to provide a player with access to video information relating to a winning outcome obtained by the player.

The system may be arranged to provide a player with access to video information relating to a winning outcome obtained by the player by storing the video information on a portable data storage device. For this purpose, the system may include a CD or DVD burner and/or a USB interface arranged to connect to a USB data storage device, and the system may be arranged to store video information on the CD/DVD or USB data storage device.

In addition or alternatively, the system may be arranged to facilitate online access to the video information from a remote location, for example through the Internet. In one embodiment, the system is arranged to allow access to the video information online by a player only after the player has been authenticated, for example by requiring the player to enter a username and password. Authorisation details may be provided to a player when a winning outcome occurs, which authorization details are usable subsequently to gain access to the video information online.

In one embodiment, the system includes a web portal provided with links to video information relating to winning outcomes obtained by players.

The game recorder may be arranged to record video information relating to entire games or only aspects of games relating to winning outcomes.

In one embodiment, the system is arranged to record video information or provide a player with access to video information relating to a winning outcome only when the winning outcome corresponds to a specific type of prize such as a jackpot prize or a prize above a specific threshold.

The gaming system may be implemented as a stand alone gaming machine or across a network.

In one embodiment, the gaming system includes at least one gaming machine, at least some of the gaming machines including a game recorder arranged to record video information indicative of a winning outcome occurring in a game implemented by the gaming system, and being arranged to provide a player with access to video information relating to a winning outcome obtained by the player. With this embodiment, each gaming machine may be provided with a memory arranged to store the video information and each gaming machine may also be provided with a CD/DVD burner or data transfer interface such as a USB interface for connecting with a portable data storage device.

In an alternative embodiment, the gaming system includes at least one gaming machine and a base station, the at least one gaming machine and the base station being connected together in networked relationship, the base station being arranged to receive video information from the or each gaming machine and including a memory arranged to store the video information. The base station may also include a CD/DVD burner or data transfer interface such as a USB interface for connecting with a portable data storage device.

The or each gaming machine may be arranged to generate a voucher when a winning outcome occurs, the voucher identifying the winning outcome and being usable to identify the video information to be provided to the player on a portable data storage device.

In accordance with a second aspect of the present invention, there is provided a method of gaming including:

implementing a probabilistic game;

determining whether an outcome of an implemented game corresponds to a winning outcome;

recording video information indicative of a winning outcome occurring in a game implemented by the gaming system; and

providing a player with access to video information relating to a winning outcome obtained by the player.

In accordance with a third aspect of the present invention, there is provided a computer program arranged when loaded into a computer to instruct the computer to operate in accordance with a gaming system arranged to implement a probabilistic game, the system including:

an outcome evaluator arranged to determine whether an outcome of an implemented game corresponds to a winning outcome; and

a game recorder arranged to record video information indicative of a winning outcome occurring in a game implemented by the gaming system;

the system being arranged to provide a player with access to video information relating to a winning outcome obtained by the player.

In accordance with a fourth aspect of the present invention, there is provided a computer readable medium having computer readable program code embodied therein for causing a computer to operate in accordance with a gaming system arranged to implement a probabilistic game, the system including:

an outcome evaluator arranged to determine whether an outcome of an implemented game corresponds to a winning outcome; and

a game recorder arranged to record video information indicative of a winning outcome occurring in a game implemented by the gaming system;

the system being arranged to provide a player with access to video information relating to a winning outcome obtained by the player.

### BRIEF DESCRIPTION OF THE DRAWINGS

Certain embodiments of the present invention will now be described, by way of example only, with reference to the accompanying drawings, in which:

FIG. 1 is a schematic block diagram of core components of a gaming system in accordance with an embodiment of the present invention;

FIG. 2 is a schematic block diagram of functional components of a gaming system in accordance with an embodiment of the present invention;

FIG. 3 is a diagrammatic representation of a gaming system in accordance with an embodiment of the present invention with the gaming system implemented in the form of a stand alone gaming machine;

FIG. 4 is a schematic block diagram of operative components of the gaming machine shown in FIG. 3;

FIG. 5 is a schematic block diagram of components of a memory of the gaming machine shown in FIG. 3;

FIG. 6 is a schematic diagram of a gaming system in accordance with an alternative embodiment of the present invention with the gaming system implemented over a network; and

FIG. 7 is a flow diagram illustrating game play of a gaming system in accordance with an embodiment of the present invention.

Features, further aspects, and advantages of the present invention will become apparent from the following description of embodiments thereof, by way of example only, with reference to the accompanying drawings. Also, various embodiments of the aspects described in the preceding paragraphs will be apparent from the appended claims, the following description and/or the accompanying drawings. It should be understood, however, that the present invention is not limited to the arrangements and instrumentality shown in the attached drawings.

### DESCRIPTION OF CERTAIN EMBODIMENTS

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements is hereby expressly defined to include a tangible medium such as a memory, DVD, CD, etc. storing the software and/or firmware.

The present gaming system operates such that at least for some game implementations a facility is available to store video information indicative of a winning outcome obtained by a player, and to provide access to the video information by the player at a later time. Access to the video information indicative of the winning outcome may be by facilitating access to the video information online, by producing a portable storage device including the video information, such as a DVD or USB drive, and providing the player with the portable storage device, or in any other way.

In this way, a player obtaining a winning outcome is able to replay the winning outcome and relive the excitement experienced.

The portable storage device may be packaged as a souvenir, and in one embodiment the video information is stored on the portable storage device in a commonly available format such as MPEG format.

Referring to the drawings, there is shown a schematic block diagram of a gaming system 10 arranged to implement a probabilistic game of the type wherein several symbols from a set of symbols are randomly displayed, and a game outcome is determined on the basis of the displayed symbols. The system may have a single mode of operation or may be of the type including multiple game modes such as operable in normal game mode wherein a base game is implemented and special game mode wherein a feature game is implemented.

With some such probabilistic games, the set of symbols used during normal game mode include standard symbols and function symbols, and the game outcome is determined on the basis of the displayed standard symbols and the function associated with any displayed function symbol. For example, standard symbols may resemble fruit such as apples, pears and bananas with a win outcome being determined when a predetermined number of the same fruit appear on a display along a win line, or are displayed according to defined outcome patterns such as scattered, and so on. The function associated with a function symbol may be for example a wild function wherein display of the function symbol is treated during consideration of the game outcome as any of the standard symbols. A function symbol may be represented as the word “WILD”, a star, or by any other suitable word or symbol. Other functions are also envisaged such as scatter functions, multiplier functions, repeat win functions, jackpot functions and feature commencement functions.

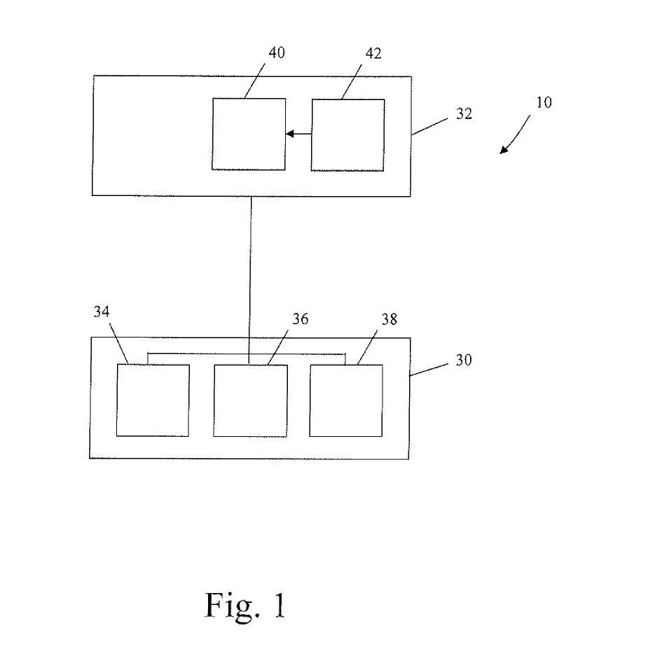

Referring to FIG. 1, a schematic diagram of core components of a gaming system 10 in accordance with the present embodiment is shown. The core components include a player interface 30 and a game controller 32. The player interface 30 is arranged to enable interaction between a player and the gaming system and for this purpose includes input/output components for the player to enter instructions and play the game.

Components of the player interface 30 may vary but will typically include a credit mechanism 34 to enable a player to input credits and receive payouts, one or more displays 36 which may include a touch screen, and a game play mechanism 38 arranged to enable a player to input game play instructions.

The game controller 32 is in data communication with the player interface 30 and typically includes a processor 40 arranged to process game play instructions and output game player outcomes to the display 36. Typically, the game play instructions are stored as program code in a memory 42 that can also be hardwired. It will be understood that in this specification the term “processor” is used to refer generically to any device that can process game play instructions and may include a microprocessor, microcontroller, programmable logic device or other computational device such as a personal computer or a server.

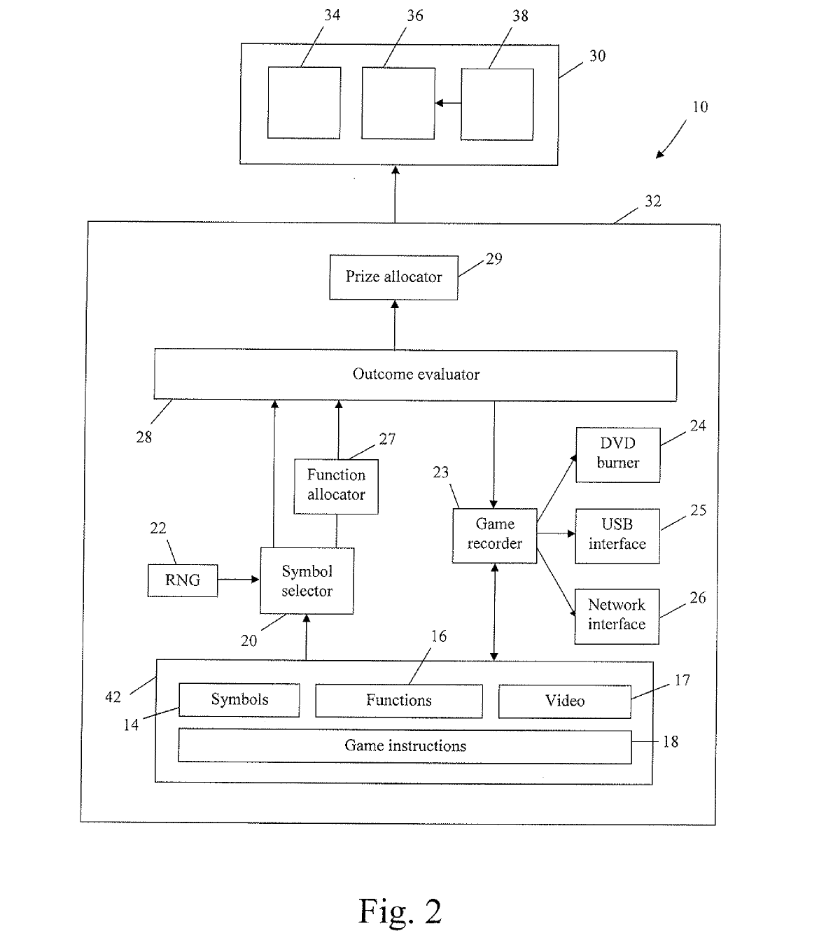

A functional diagram illustrating operative components of the game controller 32 is shown in FIG. 2.

The memory 42 is arranged to store symbols data 14 indicative of a plurality of symbols, in the present example associated with a plurality of reels, function data 16 indicative of one or more functions allocatable to the symbols, video information 17 indicative of winning outcomes obtained by players of the gaming system 10, and game instruction data 18 indicative of game instructions usable by the gaming machine 10 to control operation of the game.

In this embodiment, the video information 17 is indicative only of parts of game implementations associated with winning outcomes, although it will be understood that the video information may also be indicative of other aspects of game play including non-winning outcomes.

The video information may be stored or made available for access by a player for all winning outcomes or only for winning outcomes which satisfy specific criteria, for example if the winning outcome is of a specific type such as a jackpot winning outcome or if the prize associated with the winning outcome is above a threshold.

The game controller 32 includes a symbol selector 20 which is arranged to select several symbols from the available symbols 15 for display to a player in a plurality of display positions, in this example by spinning reels containing the symbols and stopping the reels so as to display at least one symbol on each reel. In this example, the selection carried out by the symbol selector 20 is made using a random number generator 22.

It will be appreciated that the random number generator 22 may be of a type which is arranged to generate pseudo random numbers based on a seed number, and that in this specification the term “random” will be understood accordingly to mean truly random or pseudo random.

The game controller 32 also includes a game recorder 23 arranged to generate video information indicative of game play during implementation of a game, and in this example to cause video information indicative of winning outcomes obtained by players of the gaming system to be stored in the memory 42.

The game controller 32 in this example also includes a DVD burner 24 arranged under control of the game recorder 23 to transfer video information indicative of one or more winning outcomes relating to a player to a DVD loaded into the DVD burner 24, which DVD may then be given to the player as a souvenir of the one or more winning outcomes.

The game controller 32 in this example also includes a USB interface 25 arranged under control of the game recorder 23 to transfer video information indicative of one or more winning outcomes relating to a player to a USB storage device connected during use to the USB interface 25, which USB storage device may then be given to the player as a souvenir of the one or more winning outcomes.

The game controller 32 may in addition or alternatively include a network interface 26 arranged under control of the game recorder 23 to transfer video information indicative of one or more winning outcomes relating to a player to a remote location, for example so that a DVD or USB storage device including video information indicative of one or more winning outcomes can be created at the remote location and given to the player as a souvenir of the one or more winning outcomes. The remote location may be located at a gaming venue and the DVD or USB storage device may be given to the player as the player leaves the gaming venue.

The network interface 26 may also be arranged to allow a player to connect to the gaming system 10, for example through the Internet, and access video information related to winning outcomes obtained by the player. For this purpose, the gaming system 10 may be arranged to only permit access to the video information after the player has provided appropriate authorisation information such as a login name and password. The authorisation information may be provided to a player at a gaming machine, for example on a voucher printed by the gaming machine.

In this example, the game controller 32 also includes a function allocator 27 arranged to select and allocate one or more functions to one or more symbols. Such functions include a wild function, a scatter function, or any other function which may be applied to a symbol or to the game.

The game controller 32 also includes an outcome evaluator 28 which in accordance with the game instructions 18 determines game outcomes based on the symbols selected for display to the player by the symbol selector 20 and on the special win criterion selected by a player. The outcome evaluator also liaises with the game recorder 23 so that the game recorder 23 causes video information indicative of a winning outcome to be stored in the memory 42 when a winning outcome occurs.

The game controller 32 also includes a prize allocator 29 arranged to allocate a prize to a player when a winning outcome exists.

In the embodiments described below, the symbol selector 20, the game recorder 23, the function allocator 27, the outcome evaluator 28, and the prize allocator 29 are at least partly implemented using the processor 40 and associated software, although it will be understood that other implementations are envisaged.

The gaming system 10 can take a number of different forms.

In a first form, a gaming device in the form of a stand alone gaming machine is provided wherein all or most components to implement a game, storing video information related to winning outcomes, and making the video information available to a player are present in a player operable gaming machine.

In a second form, a distributed architecture is provided wherein some of the components to implement the game, storing video information related to winning outcomes, and making the video information available to a player are present in a gaming device in the form of a player operable gaming terminal and some of the components to implement the game, storing video information related to winning outcomes, and making the video information available to a player are located remotely relative to the gaming terminal.

For example, a “thick client” architecture may be used wherein part of the game is executed on a player operable gaming terminal and part of the game is executed remotely, such as by a gaming server; or a “thin client” architecture may be used wherein most of the game is executed remotely such as by a gaming server and a player operable gaming terminal is used only to display audible and/or visible gaming information to the player and receive gaming inputs from the player.

However, it will be understood that other arrangements are envisaged. For example, an architecture may be provided wherein a gaming device is networked to a gaming server and the respective functions of the gaming device and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

It will also be understood that the mechanism for storing video information indicative of winning outcomes and making the video information available to players may be implemented locally on a stand along gaming machine, or may be distributed so that at least part of the mechanism is implemented at a location remote from the gaming device.

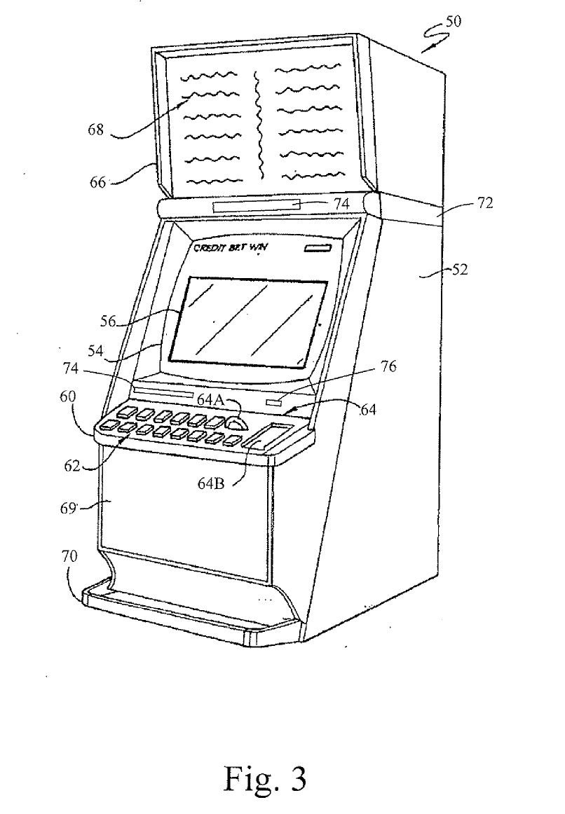

A gaming system in the form of a stand alone gaming machine 50 is illustrated in FIG. 3. The gaming machine 50 includes a console 52 having a display 54 on which is displayed representations of a game 56 that can be played by a player. A mid-trim 60 of the gaming machine 50 houses a bank of buttons 62 for enabling a player to interact with the gaming machine, in particular during gameplay. The mid-trim 60 also houses a credit input mechanism 64 which in this example includes a coin input chute 64A and a bill collector 64B. Other credit input mechanisms may also be employed, for example, a card reader for reading a smart card, debit card or credit card.

A top box 66 may carry artwork 68, including for example pay tables and details of bonus awards and other information or images relating to the game. Further artwork and/or information may be provided on a front panel 69 of the console 52. A coin tray 70 is mounted beneath the front panel 69 for dispensing cash payouts from the gaming machine 50.

The display 54 is in the form of a video display unit, particularly a cathode ray tube screen device. Alternatively, the display 54 may be a liquid crystal display, plasma screen, or any other suitable video display unit. The top box 66 may also include a display, for example a video display unit, which may be of the same type as the display 54, or of a different type. The display 54 may include a touch screen usable by a player to interact with the gaming machine, in particular during game play.

The display 54 in this example is arranged to display representations of several reels, each reel of which has several associated symbols. Typically 3, 4 or 5 reels are provided. During operation of the game, the reels first appear to rotate then stop with typically three symbols visible on each reel. Game outcomes are determined on the basis of the visible symbols together with any special functions associated with the symbols.

A player marketing module (PMM) 72 having a display 74 is connected to the gaming machine 50. The main purpose of the PMM 72 is to allow the player to interact with a player loyalty system. The PMM has a magnetic card reader for the purpose of reading a player tracking device, for example as part of a loyalty program. However other reading devices may be employed and the player tracking device may be in the form of a card, flash drive or any other portable storage medium capable of being read by the reading device. In this example, the PMM 62 is a Sentinel III device produced by Aristocrat Technologies Pty Ltd.

The gaming machine 50 also includes a slot 74 for dispensing a DVD containing video information indicative of winning outcomes and a USB connector 76 arranged to receive a portable USB storage device for the purpose of transferring video information indicative of winning outcomes to the USB storage device.

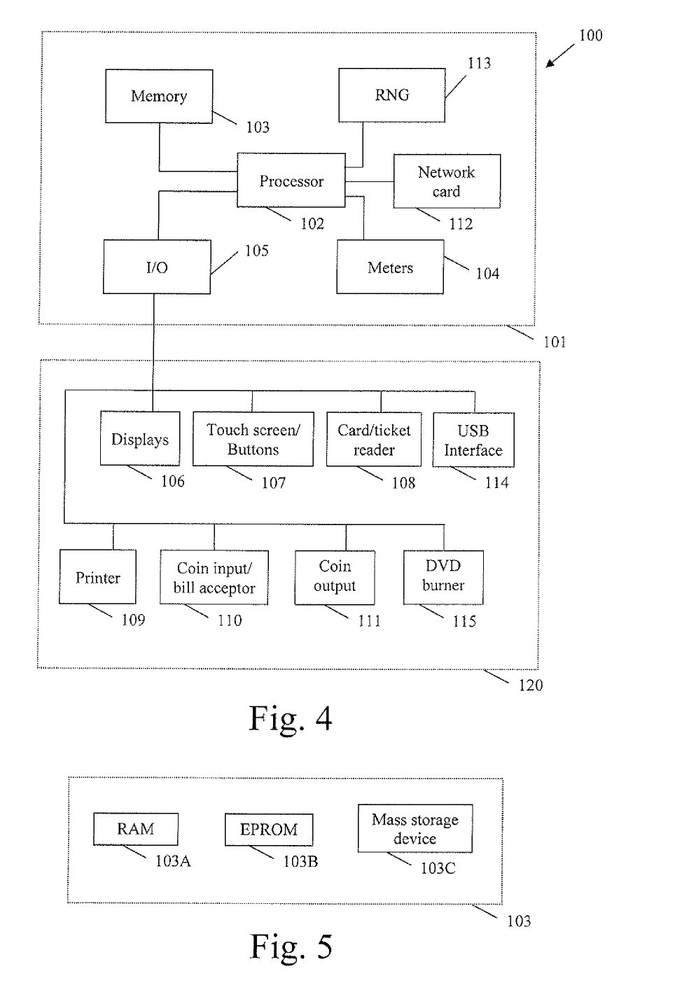

FIG. 4 shows a block diagram of operative components of a gaming machine 100 which may be the same as or different to the gaming machine shown in FIG. 3.

The gaming machine 100 includes a game controller 101 having a processor 102. Instructions and data to control operation of the processor 102 in accordance with the present invention are stored in a memory 103 which is in data communication with the processor 102.

Typically, the gaming machine 100 will include both volatile and non-volatile memory and more than one of each type of memory, with such memories being collectively represented by the memory 103.

FIG. 5 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere, and in an embodiment wherein video information is stored locally, video information indicative of winning outcomes.

The gaming machine has hardware meters 104 for purposes including ensuring regulatory compliance and monitoring player credit, an input/output (I/O) interface 105 for communicating with a player interface 120 of the gaming machine 100, the player interface 120 having several peripheral devices. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 4, the peripheral devices that communicate with the game controller 101 include one or more displays 106, a touch screen and/or bank of buttons 107, a card and/or ticket reader 108, a printer 109, a bill acceptor and/or coin input mechanism 110, a coin output mechanism 111, a USB interface and a DVD burner 115. Additional hardware may be included as part of the gaming machine 100, or hardware may be omitted based on the specific implementation.

In addition, the gaming machine 100 may include a communications interface, for example a network card 112. The network card may, for example, send status information, accounting information or other information to a central controller, server or database and receive data or commands from the central controller, server or database. The network card 112 is also arranged in this embodiment to facilitate access to video information indicative of winning outcomes from a remote location, for example through the Internet.

It is also possible for the operative components of the gaming machine 100 to be distributed, for example input/output devices 106,107,108,109,110,111 may be provided remotely from the game controller 101.

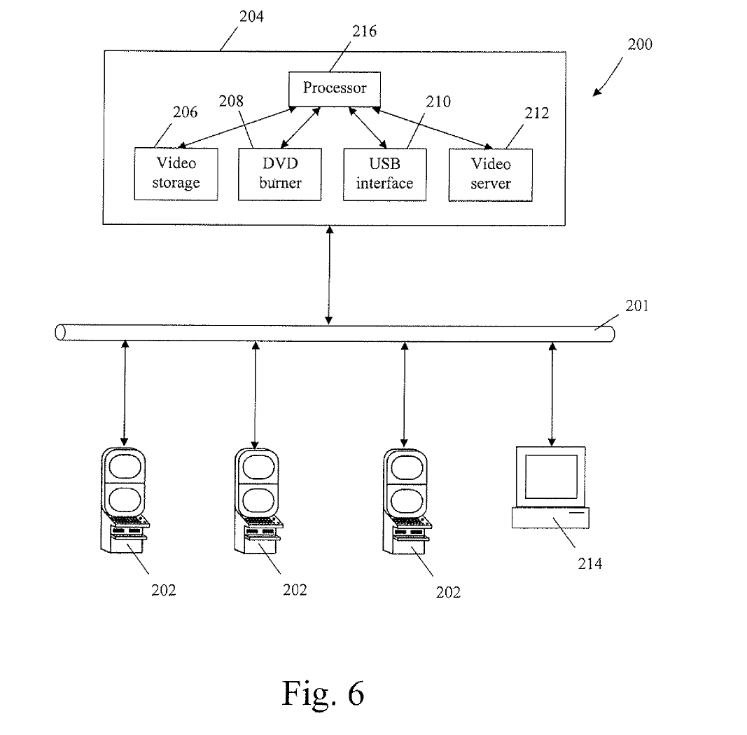

FIG. 6 shows a gaming system 200 in accordance with an alternative embodiment. The gaming system 200 includes a network 201, which for example may be an Ethernet network, a LAN or a WAN. In this example, three gaming devices 202 are connected to the network 201. The gaming devices 202 provide a player operable interface and may be similar to the gaming machines 40,100 shown in FIGS. 3 and 4, or may have simplified functionality depending on the rules, guidelines, preferences, and/or requirements for implementing game play.

The gaming system 200 also includes a base station 204 which communicates with the gaming devices 202 through the network 201, the base station 204 being arranged to receive video information indicative of winning outcomes from the gaming machines 202 through the network 201, to store the received video information in a video storage device 206, and to provide a player with access to video information related to winning outcomes obtained by the player. Access to the video information may occur by providing a DVD burner 208 and creating a DVD including video information indicative of one or more winning outcomes, or by providing a USB interface and arranging the base station 200 such that video information stored in the video storage device is transferable to a USB data storage device connected to the USB interface 210. Access to the video information may also occur by providing a video server 212 and controlling the video server 212 so as to serve video information indicative of at least one winning outcome obtained by a player to the player, for example through the Internet to a computing device 214 associated with the player.

In order to control and coordinate operations in the base station, the base station 200 also includes a processor 216. Appropriate programs may also be included for use by the processor 216 to implement the above functionality.

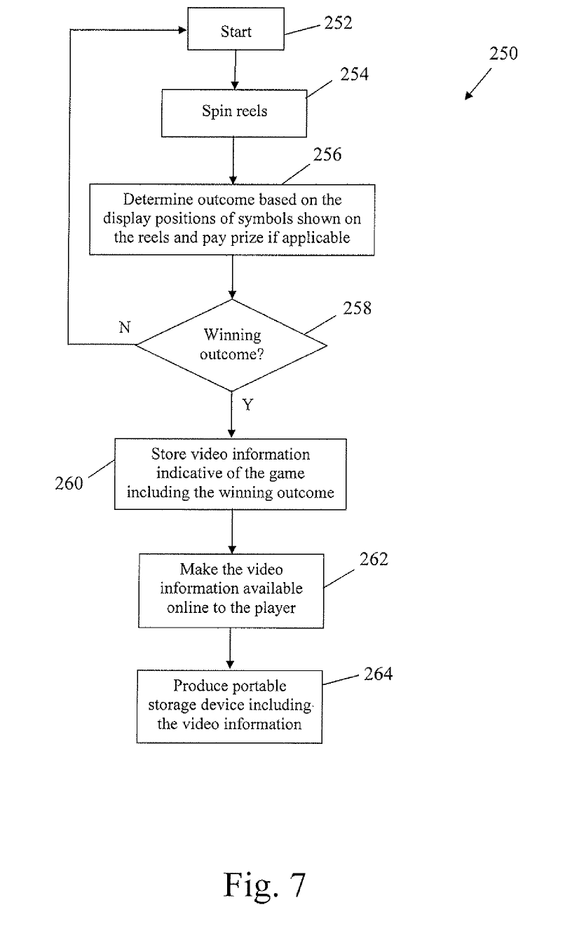

A specific example will now be described in relation to flow diagram 250 shown in FIG. 7 which illustrates steps 252 to 264 of a method of gaming implemented by a stand alone gaming machine 10, 40, although it will be understood that implementation may also be carried out using other gaming system architectures such as a network architecture of the type shown in FIG. 6.

In this example, the gaming system is of a type including five reels, each of which has an associated set of symbols.

The reels include standard symbols and optionally one or more function symbols and win outcomes are determined on the basis of the symbols visible at the display positions when the reels stop rotating.

Typically, a player will purchase or otherwise obtain win entitlements such as several win lines which are used in the game to determine win outcomes. If the displayed symbols on the reels have symbols associated with a winning combination such as disposed on a win line, the player wins a prize.

When the reels stop rotating the visible symbols are evaluated by the outcome evaluator 28 and if the displayed symbols correspond to a winning outcome a prize is awarded to the player and video information indicative of a portion of the game including obtaining the winning outcome is stored in the memory 42. The video information is then made available to the player, for example by creating a DVD including the video information, by transferring the video information to a data storage device such as a USB storage device connected to the USB interface 25, or by making the video information available for access online.

In an alternative embodiment, the video information indicative of a winning outcome obtained at a gaming venue is forwarded to a base station 200 located at the gaming venue, the base station 200 transferring the video information to a portable storage device such as a DVD or USB storage device and giving the portable storage device to the player receiving the winning outcome, for example as the player leaves the gaming venue.

In the claims of this application and in the description of certain embodiments of the invention, except where the context requires otherwise due to express language or necessary implication, the words “comprise” or variations such as “comprises” or “comprising” are used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

Modifications and variations as would be apparent to a skilled addressee are deemed to be within the scope of the present invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. It will be understood that the invention disclosed and defined in this specification extends to all alternative combinations of two or more of the individual features mentioned or evident from the text or drawings. All of these different combinations constitute various alternative aspects of the invention.

The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A gaming system arranged to implement a probabilistic game, the gaming system comprising:
an outcome evaluator arranged to determine whether an outcome of an implemented game corresponds to a winning outcome; and
a game recorder arranged to record video information in response to a winning outcome occurring in a game implemented by the gaming system and to not record any video information in response to a non-winning outcome;
the gaming system being arranged to provide a player with access to the video information relating to a winning outcome obtained by the player by transferring the video information to a portable data storage medium at the gaming system such that the player can access the video information at the same location as where the game is played.

2. A gaming system as claimed in claim 1, comprising a CD or DVD burner, the system being arranged to store video information on a CD or DVD using the CD or DVD burner.

3. A gaming system as claimed in claim 1, comprising a data transfer interface arranged to connect to a portable data storage device, the data transfer interface being arranged to transfer video information to the portable data storage device.

4. A gaming system as claimed in claim 1, wherein the system is arranged to facilitate online access to the video information from a remote location.

5. A gaming system as claimed in claim 4, wherein the system is arranged to allow access to the video information online by a player only after the player has been authenticated.

6. A gaming system as claimed in claim 5, wherein the system is arranged to provide authorisation details to a player when a winning outcome occurs, which authorization details are usable subsequently to gain access to the video information online.

7. A gaming system as claimed in claim 1, wherein the system comprises a web portal provided with links to video information relating to winning outcomes obtained by players.

8. A gaming system as claimed in claim 1, wherein the game recorder is arranged to record video information relating to entire games.

9. A gaming system as claimed in claim 1, wherein the system is arranged to record video information only when the winning outcome corresponds to defined criteria.

10. A gaming system as claimed in claim 1, wherein the system is arranged to provide a player with access to video information relating to a winning outcome only when the winning outcome corresponds to defined criteria.

11. A gaming system as claimed in claim 9, wherein the defined criteria comprises a specific type of prize or a prize above a specific threshold.

12. A gaming system as claimed in claim 1, wherein the gaming system comprises at least one gaming device, at least some of the gaming devices comprising a game recorder arranged to record video information indicative of a winning outcome occurring in a game implemented by the gaming system, and being arranged to provide a player with access to video information relating to a winning outcome obtained by the player.

13. A gaming system as claimed in claim 12, wherein each gaming device is provided with a memory arranged to store the video information.

14. A gaming system as claimed in claim 13, wherein each gaming device is provided with a CD/DVD burner or data transfer interface for connecting with a portable data storage device.

15. A gaming system as claimed in claim 1, wherein the gaming system comprises at least one gaming device in the form of a gaming machine.

16. A gaming system as claimed in claim 1, comprising a gaming terminal and a gaming server in networked communication with the gaming terminal

17. A gaming system as claimed in claim 1, comprising at least one gaming device and a base station, the at least one gaming device and the base station being connected together in networked relationship, and the base station being arranged to receive video information from the or each gaming device across the network.

18. A gaming system as claimed in claim 17, wherein the base station comprises a CD/DVD burner.

19. A gaming system as claimed in claim 17, wherein the base station comprises a data transfer interface for connecting with a portable data storage device.

20. A gaming system as claimed in claim 1, wherein the gaming system is arranged to generate a voucher when a winning outcome occurs, the voucher identifying the winning outcome and being usable to identify the video information to be provided to the player.

21. A method of gaming comprising:
implementing a probabilistic game;
determining whether an outcome of an implemented game corresponds to a winning outcome; and
recording video information in response to a winning outcome occurring in a game implemented by the gaming system and not recording any video information in response to a non-winning outcome; and
providing a player with access to the video information relating to a winning outcome obtained by the player by transferring the video information to a portable data storage medium at the gaming system such that the player can access the video information at the same location as where the game is played.

22. A method as claimed in claim 21, comprising burning a CD or DVD containing the video information.

23. A method as claimed in claim 21, comprising providing a USB interface, connecting a USB data storage device to the interface and transferring the video information to the USB data storage device.

24. A method as claimed in claim 21, comprising facilitating online access to the video information from a remote location.

25. A method as claimed in claim 24, comprising allowing access to the video information online by a player only after the player has been authenticated.

26. A method as claimed in claim 25, comprising providing authorisation details to a player when a winning outcome occurs, which authorization details are usable subsequently to gain access to the video information online.

27. A method as claimed in claim 21, comprising providing a web portal provided with links to video information relating to winning outcomes obtained by players.

28. A method as claimed in claim 21, comprising recording video information relating to entire games.

29. A method as claimed in claim 21, comprising recording video information relating to a winning outcome only when the winning outcome corresponds to defined criteria.

30. A method as claimed in claim 21, comprising providing a player with access to video information relating to a winning outcome only when the winning outcome corresponds to defined criteria.

31. A method as claimed in claim 29, wherein the defined criteria comprises a specific type of prize such as a jackpot prize or a prize above a specific threshold.

32. A method as claimed in claim 21, comprising providing a gaming device, recording video information indicative of a winning outcome at the gaming device, and providing a player with access to video information stored at the gaming machine.

33. A method as claimed in claim 32, comprising burning at the gaming device a CD or DVD containing the video information.

34. A method as claimed in claim 32, comprising providing a gaming device with a data transfer interface, connecting a portable data storage device to the data transfer interface, and transferring video information to the portable data storage device connected to the data transfer interface.

35. A method as claimed in claim 21, comprising providing at least one gaming device and a base station, connecting the at least one gaming device and the base station together in networked relationship, receiving video information from the or each gaming device and storing the video information at the base station.

36. A method as claimed in claim 35, comprising burning at the base station a CD or DVD containing the video information.

37. A method as claimed in claim 35, comprising providing the base station with a data transfer interface, connecting a portable data storage device to the data transfer interface, and transferring video information to the portable data storage device connected to the data transfer interface.

38. An article of manufacture comprising:
a computer readable storage medium; and
executable program instructions embodied in the computer readable storage medium that when executed by a programmable system cause the system to perform functions that implement a gaming system arranged to implement a probabilistic game, the functions comprising:
an outcome evaluator arranged to determine whether an outcome of an implemented game corresponds to a winning outcome; and
a game recorder arranged to record video information in response to a winning outcome occurring in a game implemented by the gaming system and to not record any video information in response to a non-winning outcome;
the system being arranged to provide a player with access to the video information relating to a winning outcome obtained by the player by transferring the video information to a portable data storage medium at the gaming system such that the player can access the video information at the same location as where the game is played.
